(19) United States
(12) Patent Application Publication
(10) Pub. No.: US 2007/0235913 A1
(43) Pub. Date: Oct. 11, 2007

(54) Methods and manufacturing of a composite shock-absorbing structure thereof

(75) Inventors: Katsu-Hiko Chien, Taichung (TW); Chishima Kazuo, Saitama City (JP)

Correspondence Address: BIRCH STEWART KOLASCH & BIRCH, PO BOX 747, FALLS CHURCH, VA, 22040-0747, US

(73) Assignee: I CHU SPRING CO., LTD.

(21) Appl. No.: 11/394,106

(22) Filed: Mar. 31, 2006

(51) Int. Cl. F16F 1/36

(52) U.S. Cl. 267/149

(57) ABSTRACT

A composite shock-absorbing material comprised of kernel material, winding material, and a resin layer, and where the kernel material is spiraled by the winding material. A resin layer covers both the surfaces of both the kernel material and the winding material. Hence, the composite shock-absorbing material of the present invention is formed. A method of forming the composite shock-absorbing material includes providing kernel material and forming a winding material spiraling the kernel material and then forming a resin layer on the surfaces of the kernel material and the winding material.

### BACKGROUND

1. Field of Invention

The present invention relates to a composite shock-absorbing structure. More particularly, the present invention relates to methods and the manufacturing of a composite shock-absorbing structure and a shock-absorbing product of a composite shock-absorbing structure.

2. Description of Related Art

With developments in industry, mechanical engineering equipment is broadly employed from heavy-duty engineering facilities to general transportation equipment. Generally, vibrations often occur when mechanical engineering equipment is operated. Thus, shock absorbers are naturally installed on mechanical engineering equipment to damp vibrations during operation so as to prevent the negative effects of vibrations on users, the mechanical engineering equipment itself, or both and further reducing usage and maintenance problems.

Readily available metallic materials and readily available elastic materials are commonly used to manufacture shock-absorbing structures and are used to manufacture either metal shock-absorbing structures or elastic shock-absorbing structures respectively. The metal shock-absorbing structures usually have higher rigidity and strength loading performances for both normal/axial stress and shear stress than the elastic shock-absorbing structures. The application range of the metal shock-absorbing structures is therefore broader. But, some negative characteristics of the metal materials such as poor damping performance and brittleness in low ambient temperatures heavily influence the loading performance of the metal in metal shock-absorbing structures. Moreover, the resistance of metal to either acid, alkalis, or both is also poor and acids and alkalis may both easily erode metal. Acidic and alkaline erosion of metal reduces the life of the metal. To prevent this erosion, usually one or more anti-corrosion layer is placed on the surface of the metal to improve the resistance and life of the metal in metal shock-absorbing structures. In such cases, the cost of the metal shock-absorbing structure inevitably increases.

Elastic shock-absorbing structures have better damping performances than metal shock-absorbing structures But the loading performances of elastic shock-absorbing structures are influenced and sharply lowered by its poor rigidity and strength. The rigidity and strength of elastic materials is poor when exposed to both normal/axial stress and shear stress. Also, the loading performance and the application scope of elastic shock-absorbing structures are easily influenced and decided by the operating environment.

It is readily known from the aforementioned descriptions that many compositions of materials are commonly used in shock-absorbing structures. Metal shock-absorbing structures usually perform with higher loading stresses than elastic shock-absorbing structures but the metal shock-absorbing structures are often exposed to heavier weights than elastic shock-absorbing structures when used in the field. The use of elastic materials in elastic shock-absorbing structures generally reduces the weight of the shock-absorbing structures but they can only handle loading weights lighter than the loading weights the metal shock-absorbing structures can handle.

Nowadays, many compound materials are broadly applied to many different shock-absorbing structures (such as springs). For example, alloys are often used as the metal in metal shock-absorbing structures. Resin or fiber materials are frequently used as the elastic material in elastic shock-absorbing structures. The purposes of the compositions of compound materials are to obtain better rigidity performances, increase the strength and reduce the weight of the structure.

Generally, the rigidity and strength of some selected alloys, which are used in shock-absorbing structures, are higher than the rigidity and strength of more common metals. In addition, the acid/alkali resistance of some selected alloys are better than the resistance for some common metals. Besides, the weight of alloy materials is usually between the weight of common metal and the weight of compound materials used in the same shock-absorbing structure. But the cost of alloys is often higher than the cost of more common metal. Thus, the cost of a shock-absorbing structure is raised when the alloys are used.

In addition, composite shock-absorbing structures are formed when compound materials, such as resin and fiber materials are used in shock-absorbing structures. Resin and fiber material are lighter and cheaper than metal alloys. Although the axial-stress strength of the fiber materials is equivalent to the axial-stress strength of metal, the shear-stress strength of the fiber material is much lower than the shear-stress strength of metal. Therefore, the entire rigidity and strength of the composite shock-absorbing structures are limited and loading performances are also restricted.

For the forgoing reasons, there is a need for the provision of a composite shock-absorbing structure with a higher loading performance than the conventional one.

### SUMMARY

The present invention is directed to methods and manufacturing of a composite shock-absorbing structure and a shock-absorbing product of the composite shock-absorbing structure, that satisfies this need. The composite shock-absorbing structure comprises a kernel material, a winding material and a resin layer.

It is therefore an objective of the present invention to provide a composite shock-absorbing structure with higher rigidity and strength than the conventional composite shock absorbers.

It is another objective of the present invention to provide a composite shock-absorbing structure that is lighter than a metal shock-absorbing structure but with higher rigidity and more strength than a metal shock-absorbing structure.

It is still another objective of the present invention to provide methods of manufacturing a composite shock-absorbing structure to reduce the manufacturing processes of conventional composite shock-absorbing structures where the provision of the present invention of the composite shock-absorbing structure reduces the shaping process during the manufacturing process.

It is yet another objective of the present invention to provide a shock-absorbing product with one or more composite shock-absorbing structures of the present invention, which decreases the cost of manufacturing processes without the preceding shaping process.

In accordance with the foregoing and other objectives of the present invention, providing a composite shock-absorbing structure comprising a kernel material, a winding material and a resin layer. The kernel material is spiraled by the winding material in a specified way. The surfaces of both the kernel material and the winding material are covered with resin to form a resin layer. The composite shock-absorbing structure is then made.

In one embodiment of the present invention, a composite shock-absorbing structure comprises of kernel material, winding material and a resin layer. The rigidity and strength of the composite shock-absorbing structure is greatly increased by the combination of the kernel material and the winding material where the winding material spirals the kernel material in a specific manner. The resin material further consolidates this combination where the resin layer completely covers the kernel material and the winding material. Therefore, the strength of the composite shock-absorbing structure is increased with improvements in strength of normal axial stress and shear axial stress. Hence, the composite shock-absorbing structure of the present invention obtains some better practical performances, such as noise reduction (better damping performance performed by this combination), is lighter than a metal shock-absorbing structure, is lighter with certain strength and rigidity as compared with metal shock-absorbing structures, having higher strength and rigidity as compared with other composite shock-absorbing structures.

In another embodiment of the present invention, a composite shock-absorbing structure, comprises of kernel material, winding material, and a resin layer. The winding material (such as a cord) spirals the kernel (such as a metallic/elastic bar) where the kernel material and the winding material are both consolidated by the resin layer covering the kernel material and the winding material. This firm composite shock-absorbing structure is then manufactured.

In still another embodiment, the composite shock-absorbing structure further comprises a covering layer. The covering layer surrounds and covers the resin layer to retain the shape and formation of the composite shock-absorbing structure and further protects the composite shock-absorbing structure from being damaged. Moreover, the state of structure formation of the composite shock-absorbing structure is more secure.

In yet another embodiment of the present invention, providing a composite shock-absorbing structure having a covering layer, which surrounds and covers the kernel material, the winding material and the resin layer. The covering layer makes the resin layer uniform on the surfaces of the core and the cord and further strengthens the stability of the composite shock-absorbing structure. In one embodiment of the present invention, made in a spring shape by twisting the composite shock-absorbing structure with the spring-forming facilities. A shock-absorbing product of a composite shock-absorbing structure is then formed after the heating process. In the processes of manufacturing the foresaid shock-absorbing product of the composite shock-absorbing structure, there's no need to implement a forming process by a forming die (a molding facility) to form the outline of the composite shock-absorbing structure. A shape-molding process of manufacturing the composite shock-absorbing structure is then successfully expelled. The expelled shape-molding process allows for a reduction in the cost of production.

In an embodiment of a method for making a composite shock-absorbing structure, the method includes providing a kernel material, and a winding material spiraling the kernel material in a specific manner. In such an embodiment of manufacturing the composite shock-absorbing structure, a specific twisting manner for the winding material winding round the kernel material on both surfaces of the winding material and/or the kernel material. In addition, in still one embodiment of a method of forming a composite shock-absorbing structure, further comprising a covering layer that covers all over the kernel material, the winding material and the resin layer.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows the cross-section of a composite shock-absorbing structure in one preferred embodiment of the present invention.

FIG. 2A and FIG. 2B illustrate the cross-section of a composite shock-absorbing structure with a covering layer in another embodiment of the present invention.

FIG. 3A-FIG. 3D show the processing diagram of fabricating a shock-absorbing product of a composite shock-absorbing material in another preferred embodiment of the present invention.

FIG. 4 illustrates a side view of a composite shock-absorbing structure in one preferred embodiment of the present invention.

FIG. 5 shows the cross-section of a composite shock-absorbing structure in one embodiment of the present invention.

FIG. 6 illustrates the cross-section of a composite shock-absorbing structure in another embodiment of the present invention.

FIG. 7 illustrates the cross-sections of the kernel materials and the winding materials in still one embodiment of the present invention.

FIG. 8 illustrates the cross-sections of the kernel materials and the winding materials in still another embodiment of the present invention.

FIG. 9 shows a cross-section of a composite shock-absorbing structure 100 in yet another embodiment of the present invention.

FIG. 10 illustrates the cross-section of a composite shock-absorbing structure in one embodiment of the present invention.

FIG. 11 shows a diagram of a usage of a composite shock-absorbing structure in one embodiment of the present invention.

FIG. 12 indicates another usage of a plurality of composite shock-absorbing structures in one embodiment of the present invention.

### DESCRIPTION OF THE PREFERRED EMBODIMENTS

Reference will now be made in detail to the present preferred embodiments of the invention, examples of which are illustrated in the accompanying drawings Wherever possible, the same reference numbers are used in the drawings and the description to refer to the same or like parts.

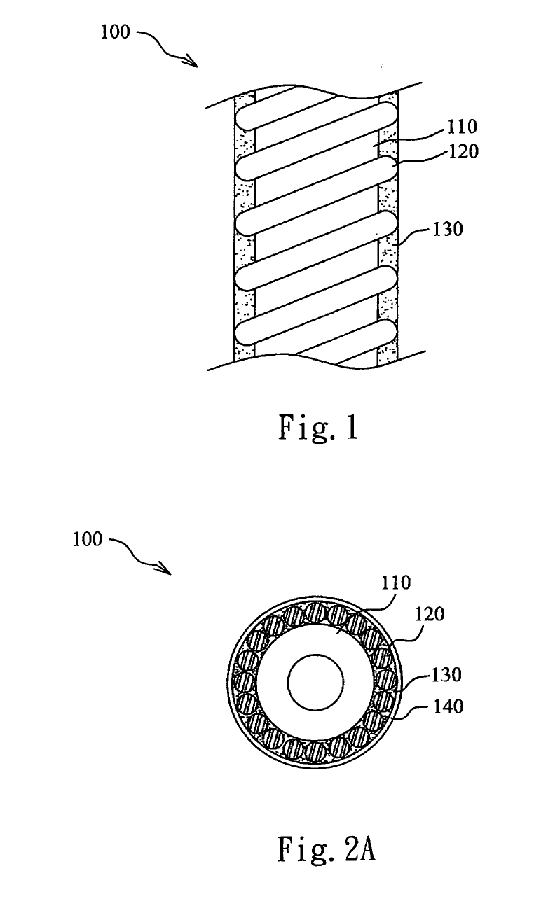

FIG. 1 shows the cross-section of a composite shock-absorbing structure in one preferred embodiment of the present invention where the composite shock-absorbing structure 100 comprises a kernel material 110, a winding material 120, and a resin layer 130.

The kernel material 110 is the core body of the composite shock-absorbing structure 100. The cross-section profiles of the kernel material 110 can be shaped into a cylinder or into a polygon, which may be hollow or solid, such as a hollow/solid cylinder bar or a hollow/solid polygon bar. The kernel material 110 is a metal or a fiber, for example, carbon fiber, glass fiber, nylon fiber or metallic fiber and so on. The winding material 120 spirals on the kernel material 110.

The winding material 120 spirals tightly on the kernel material 110 to strengthen the rigidity and strength of the kernel material 110 where the winding material 120 is one or more strands of cord material. The shock-absorbing ability of the composite shock-absorbing structure 100 is effectively increased. The winding material 120 is a fiber material, such as a carbon fiber, a glass fiber, a nylon fiber, or a composition thereof. The resin layer 130 is then coated on the surfaces of the kernel material 110 and the winding material 120.

The resin layer 130 is a thin or thick blanket of resin material attached to the surfaces of the kernel material 110 and the winding material 120 to consolidate the formation of the composite shock-absorbing structure 100. In addition, the resin layer 130 is also used for increasing the strength of the combination of the kernel material 110 and the winding material 120. This also helps to increase the strength and rigidity of the composite shock-absorbing structure 100. The resin layer 130 includes a thermosetting resin where the thermosetting resin is a fluid at room temperature and solidifies when heated up. Different types of resin layer 130, for example, an anti-corrosion resin such as an acrylonitrile butadiene styrene resin (ABS resin) may be used to accommodate the operating environment of the composite shock-absorbing structure 100. The resin layer 130 material includes epoxy resin, polyester, phenol resin, or a composition thereof.

In one embodiment of the present invention, a method of manufacturing a composite shock-absorbing structure 100 comprises of at least two steps, a first step and a second step. The first step includes having one or more kernel material 110, and one or more winding material 120 to wind round the kernel materials 110 in a specified manner. The second step includes coating resin on both surfaces of the kernel materials 110 and the winding materials forming a resin layer 130. Consequently, the composite shock-absorbing structure 100 is manufactured.

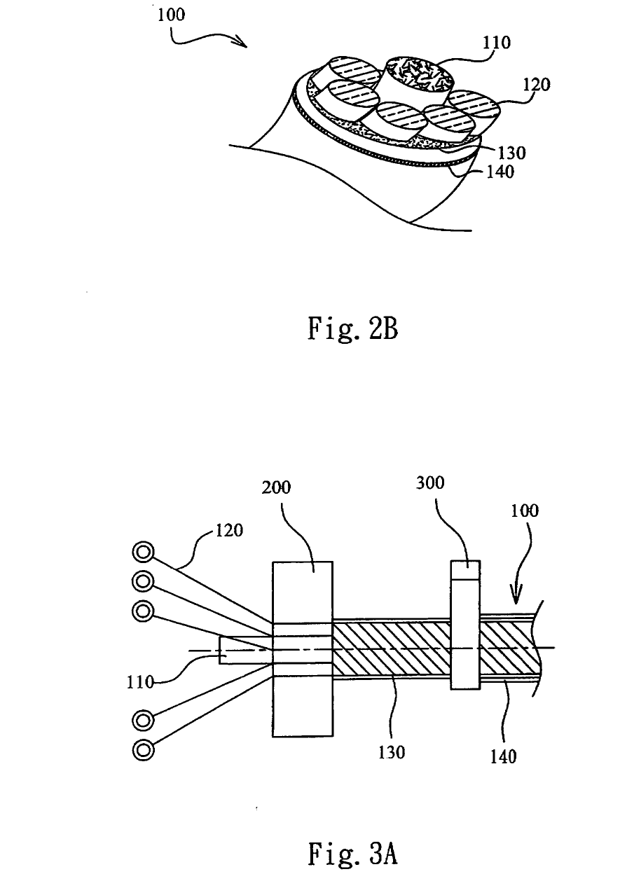

In addition, in the aforementioned embodiment of the present invention, the composite shock-absorbing structure 100 further comprises a covering layer 140. FIG. 2A and FIG. 2B illustrate the cross-section of the aforesaid composite shock-absorbing structure 100 with a covering layer 140. The composite shock-absorbing structure 100 comprises a kernel material 110, one or more winding materials 120, a resin layer 130 and a covering layer 140.

The covering layer 140 is a thin layer surrounded and completely covers the resin layer 130. The covering layer 140 further allows the resin layer 130 retain more uniformity on the surfaces of the kernel material 110 and the winding material 120 when the resin layer 130 remains a fluid. The covering layer wraps up the resin layer 130 that also provides an outer protection and an inner consolidation to the composite shock-absorbing structure 100. The stability of the composite shock-absorbing structure 100 is therefore increased. The covering layer 140 materials include elastic material, for example, a plastic material such as a thermosetting film or a heat shrinkable film.

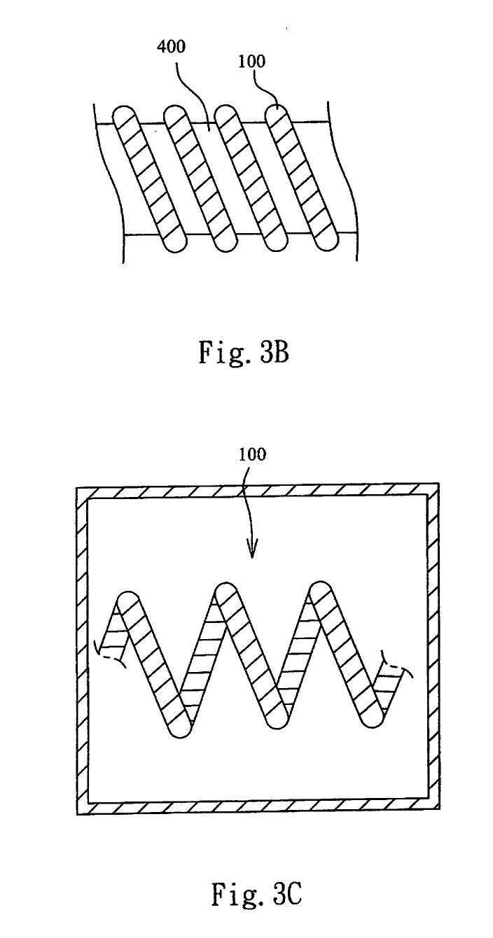

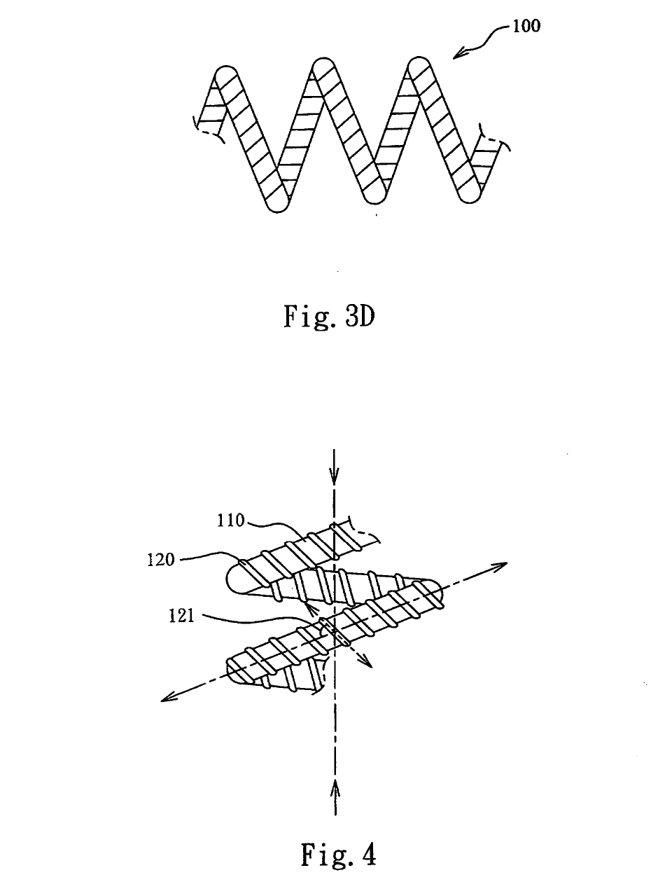

FIG. 3A-3D show the processing diagram of fabricating a shock-absorbing product of a composite shock-absorbing material in another preferred embodiment of the present invention. The shock-absorbing product is shaped like a spring with at least one composite shock-absorbing structure 100 where the composite shock-absorbing structure 100 comprises a kernel material 110, a winding material 120, a resin layer 130 and a covering layer 140. As shown in FIG. 3A, the winding material 120 winds round the kernel material 110 with twisting equipment 200 and then resin is coated on both kernel material 110 and the winding material 120 forms a resin layer 130. Thereafter, the covering layer 140 wraps up the resin layer 130 by using a wrapping equipment 300. A composite shock-absorbing structure 100 is then performed. FIG. 3B shows the composite shock-absorbing structure 100 is formed like a spring by using spring-forming equipment 400. FIG. 3C illustrates the final pattern of this shock-absorbing product in a spring shape, which includes at least one composite shock-absorbing structure 100, is heated up by a heating facility and then the shock-absorbing product formed (as shown in FIG. 3D).

Moreover, in one embodiment of the present invention, methods of manufacturing a composite shock-absorbing structure 100 further includes immersing one or more kernel material 110 and one or more winding material 120 into a resin basin to make sure that the resin material totally covers the kernel materials 110 and the winding materials 120. The resin layer 130 is then formed. The winding materials then wind round the kernel materials 110. Thereafter, the composite shock-absorbing structure 100 is formed where a covering layer 140 is completely wrapped around the resin layer 130, the winding materials 120 and the kernel materials 110.

It is readily to know by the aforementioned embodiments of the present invention that the resin layer 130 consolidates the combination of the kernel materials 110 and the winding material 120 and strengthens the rigidity and increases the strength of the composite shock-absorbing structure 100. This allows the composite shock-absorbing structure 100 to have a more stable outline and structure until the manufacturing processes are completed. Without using any molding facility or manufacturing processes, the outline and structure of the composite shock-absorbing structure 100 is still obtained. Thus, the composite shock-absorbing structure 100 can be directly heated by the heating facilities and then formed. Consequently, the cost and the steps of the processes of manufacturing the composite shock-absorbing structure is effectively decreased and reduced.

FIG. 4 illustrates a side view of a composite shock-absorbing structure 100 in one preferred embodiment of the present invention, in which a winding material 120 winds round a kernel material 110 in a specific manner with a spiral angle 121. The range of the spiral angle 121 is often between thirty degrees to sixty degrees. Among which, the spiral angel 121 is equal to 45 degrees that makes the composite shock-absorbing structure 100 have the best rigidity and strength performance. This is because the acting force of the winding material 120 is equally divided into normal axial stresses and shear axial stresses. The rigidity and strength of the composite shock-absorbing structure 100 is effectively increased.

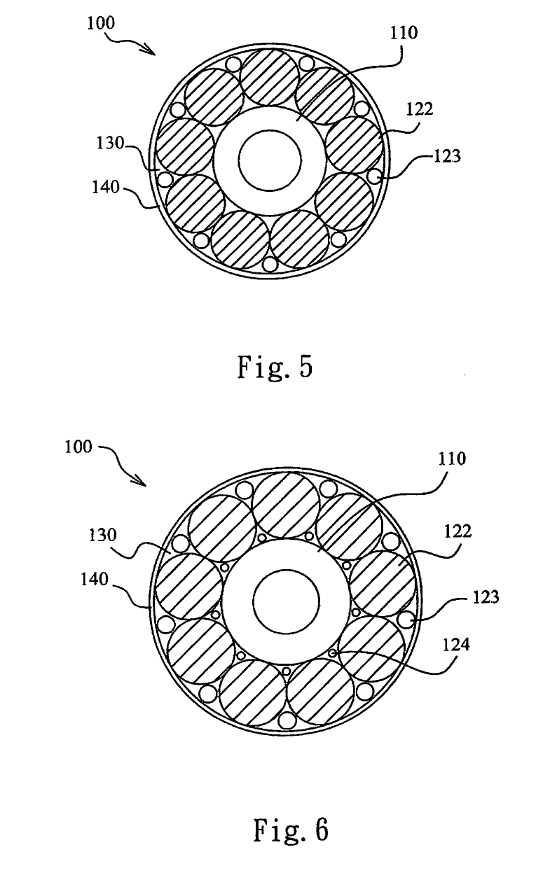

FIG. 5 shows the cross-section of a composite shock-absorbing structure in one embodiment of the present invention. The composite shock-absorbing structure 100 according to the disclosed principles comprises a kernel material 110, the winding materials 120, a resin layer 130 and a covering layer 140. Where the winding materials are two types of winding materials 120, which are respectively one or more first winding material 122 and one or more second winding material 123. The diameters of the first winding material 122 and the second winding material 123 are different. The first winding material 122 and the second winding material 123 are tightly spiraled around the kernel material 110. With such a combination of a plurality of winding materials 120, the rigidity and strength of the composite shock-absorbing structure 100 is further upgraded. The loading performance of the composite shock-absorbing structure 100 is therefore increased.

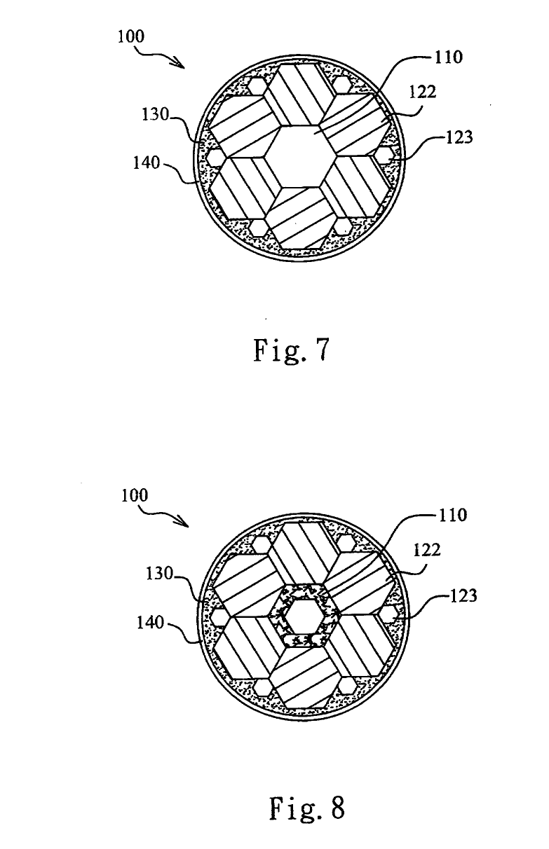

FIG. 6 illustrates the cross-section of the aforementioned composite shock-absorbing structure 100 in FIG. 5 further comprising of one or more winding materials 124. The third winding materials 124 are located between the first winding materials 122 and the second winding materials 123 where one or more third winding material 124 wind round the kernel material 110 with the first winding materials 122 and the second materials 123 at the same time. The diameter of the third winding material 124 is smaller than the second winding material 123 and the diameter of the second winding material 123 is smaller than the first winding material 122. Without doubt, the rigidity and strength of the composite shock-absorbing structure 100 is obviously improved and the resin usage amount of the resin layer 130 is further decreased without compromising the rigidity and strength of the composite shock-absorbing structure. In addition, please refer to FIG. 7 and FIG. 8, which both respectively illustrate the cross-sections of the kernel materials 110 and the winding materials 120 in two embodiments of the present invention. The kernel materials 110 can be specified in hollow or solid polygon and the winding materials 120 can be specified in a polygon, such as a hexagon.

FIG. 9 shows a cross-section of a composite shock-absorbing structure 100 in yet one embodiment of the present invention. The composite shock-absorbing structure 100 according to the disclosed principles comprises a kernel material 110, a winding material 120, a resin layer 130, and a covering layer 140. The kernel material 110 is replaced by a winding material 120 so the winding materials 120 of the composite shock-absorbing structure 100 directly wind round each other tightly so that the rigidity and strength of the composite shock-absorbing structure 100 is also effectively increased. In such cases, the kernel material 110 and the winding material 120 includes a hollow or solid polygon and a hollow or solid circle.

In addition, in one embodiment of the foresaid composite shock-absorbing structure 100, the kernel material 110 is substituted by a winding material 120, therefore, the volume and the weight can be minimized without reducing and compromising the loading performance of the strength and rigidity of the composite shock-absorbing structure 100.

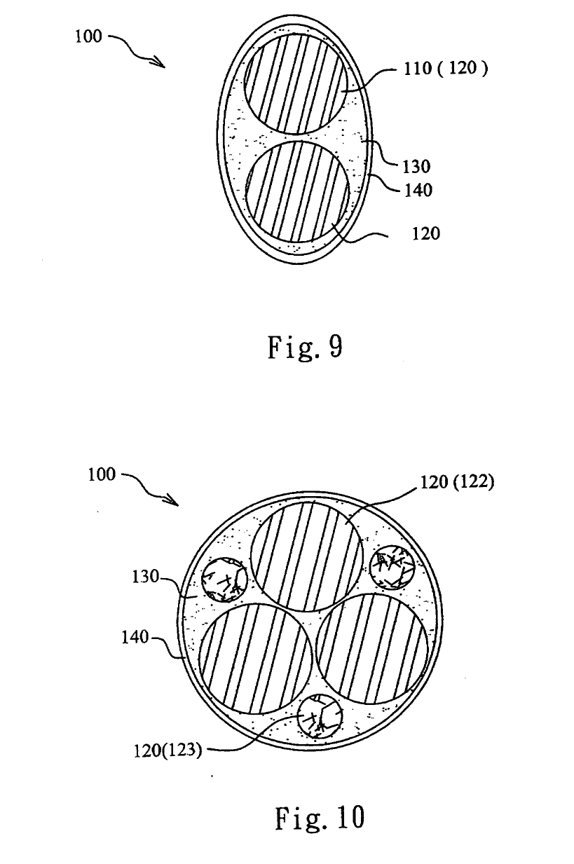

FIG. 10 illustrates the cross-section of a composite shock-absorbing structure 100 in one embodiment of the present invention. The composite shock-absorbing structure 100 according to the disclosed principles comprises a kernel material 110, a plurality of winding materials 120, a resin layer 130 and a covering layer 140 in which the kernel material 110 is replaced by a plurality of winding materials 120 having different diameters. In this case, the plurality of winding materials 120 comprises a of a first winding material 122 and a second winding material 123. The rigidity and strength of the composite shock-absorbing structure 100 can be easily increased according to the foresaid forming structure of the composite shock-absorbing structure 100.

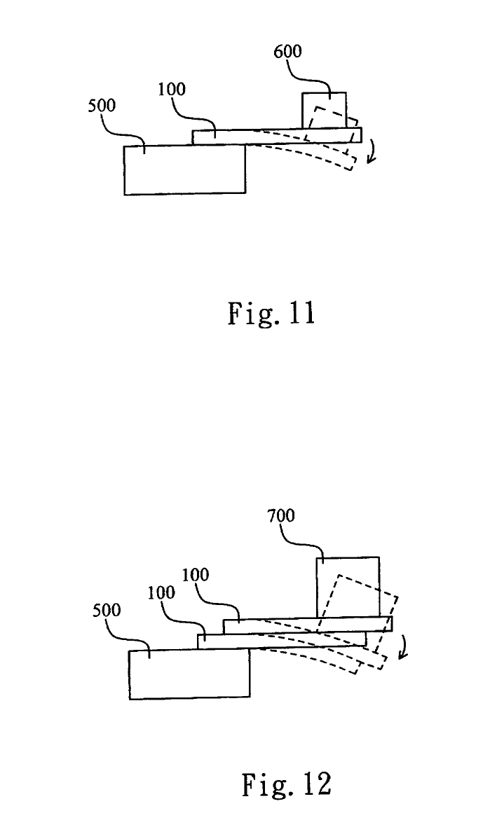

FIG. 11 shows a diagram of a usage of a composite shock-absorbing structure 100 in one embodiment of the present invention. The diagram illustrates a composite shock-absorbing structure 100, a fixing base 500, a first heaving loading 600 where the composite shock-absorbing structure 100 with a bar-shaped outline is formed according to the disclosed principles. One end of the composite shock-absorbing structure 100 is fixed on the fixing base 500. The other end of the composite shock-absorbing structure 100 is loaded with the first heavy loading 600 without any permanent deformation occurring during operation. In this case, a metallic shock absorber of a suspension system in a vehicle may be replaced with this lighter composite shock-absorbing structure 100 with the same rigidity and strength as the metallic shock absorber.

FIG. 12 indicates another usage of a plurality of composite shock-absorbing structures 100 in one embodiment of the present invention. A plurality of composite shock-absorbing structures 100 are all combined together and fixed on the fixing base 500 with one end at the bottom of these composite shock-absorbing structures 100. The other end at the top one of these composite shock-absorbing structures 100 is loaded with a second heaving loading 700 where the second heavy loading 700 is heavier than the first heavy loading 600. It is readily to know that the loading performances of these bar-shaped composite shock-absorbing structures 100 can be easily increased by the aforementioned usages.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A composite shock-absorbing structure, comprising:
a kernel material;
a winding material, spiraling on the kernel material; and
a resin layer, attaching and covering on the surfaces of the kernel material and the winding material.

2. The composite shock-absorbing structure of claim 1, wherein the kernel material is either a hollow bar or a solid bar.

3. The composite shock-absorbing structure of claim 1, wherein the kernel material has a circular cross-section profile or a polygonal cross-section profile.

4. The composite shock-absorbing structure of claim 1, wherein the kernel material is composite material.

5. The composite shock-absorbing structure of claim 1, wherein the composite material is a fiber material.

6. The composite shock-absorbing structure of claim 1, wherein the winding material is a fiber material.

7. The composite shock-absorbing structure of claim 6, wherein the fiber material includes carbon fiber, glass fiber, kevler fiber, nylon fiber or a composition thereof.

8. The composite shock-absorbing structure of claim 1, further comprising a covering layer, the covering layer surrounds and covers the resin layer.

9. The composite shock-absorbing structure of claim 8, wherein the covering layer is a plastic material.

10. The composite shock-absorbing structure of claim 9, wherein the plastic material is a thermosetting film or a heat shrinkable film.

11. A method of forming a composite shock-absorbing structure, comprising providing kernel material;
forming winding material spiraling around the kernel material;
forming a resin layer on the winding material.

12. The method of forming a composite shock-absorbing structure of claim 11, wherein the kernel material is a hollow bar or a solid bar.

13. The method of forming a composite shock-absorbing structure of claim 11, wherein the kernel material has a circular cross-section profile or a polygonal cross-section profile.

14. The method of forming a composite shock-absorbing structure of claim 11, wherein the kernel material and the winding material are composite material.

15. The method of forming a composite shock-absorbing structure of claim 14, wherein the composite material includes fiber material.

16. The method of forming a composite shock-absorbing structure of claim 11, wherein the resin layer is a resin material and the resin material is either an epoxy resin, a polyester, a phenol resin or a composition thereof.

17. The method of forming a composite shock-absorbing structure of claim 16, wherein the resin material further comprises a thermosetting resin or an anti-corrosion resin.

18. The method of forming a composite shock-absorbing structure of claim 11, further comprising a method of forming a covering layer on the resin layer.

19. The method of forming a composite shock-absorbing structure of claim 18, wherein the covering layer is a plastic material.

20. The method of forming a composite shock-absorbing structure of claim 19, wherein the plastic material is a thermosetting film or a heat shrinkable film.

21. A shock-absorbing product, including a composite shock-absorbing structure, the composite shock-absorbing structure further comprising
a kernel material;
a winding material spiraling the kernel material;
a resin layer, attaching and covering the surfaces of the kernel material and the winding material;
wherein the shock-absorbing structure has a spring shape and is formed by the composite shock-absorbing structure.

22. The shock-absorbing product of claim 21, wherein the kernel material is a hollow bar or a solid bar.

23. The shock-absorbing product of claim 21, wherein the kernel material has a circle cross-section profile or a polygon cross-section profile.

24. The shock-absorbing product of claim 21, wherein the kernel material and the winding material are composite material.

25. The shock-absorbing product of claim 21, wherein the composite material includes fiber material.

26. The shock-absorbing product of claim 21, wherein the resin layer is a resin material and the resin material includes an epoxy resin, a polyester, a phenol resin or a composition thereof.

27. The shock-absorbing product of claim 21, further comprising a covering layer covers the resin layer.

28. The shock-absorbing product of claim 27, wherein the covering layer is a plastic material.

29. The shock-absorbing product of claim 28, wherein the plastic material is a thermosetting film or a heat shrinkable film.
